(19) United States
(12) Patent Application Publication
(10) Pub. No.: US 2003/0165601 A1
(43) Pub. Date: Sep. 4, 2003

(54) Food processing method and apparatus

(76) Inventor: Mark Terry, Pocatello, ID (US)

Correspondence Address: FENWICK & WEST LLP, SILICON VALLEY CENTER, 801 CALIFORNIA STREET, MOUNTAIN VIEW, CA, 94041, US

(21) Appl. No.: 10/140,735

(22) Filed: May 7, 2002

Related U.S. Application Data
(63) Continuation-in-part of application No. 09/713,526, filed on Nov. 13, 2000, now Pat. No. 6,551,641.

(51) Int. Cl. A23K 1/00

(52) U.S. Cl. 426/332

(57) ABSTRACT

Processing apparatus and method for animal products include multiple successive immersions in sanitizing solutions at different successive temperatures within controlled environments including at fluid pressures different from ambient pressure to reduce resident microbial contaminants in preparation for packaging and retail distribution.

### RELATED CASES

This application is a continuation-in-part of pending application Ser. No. 09/713,526 entitled “Fish, Poultry, Meat Processing Method and Apparatus”, filed on Nov. 13, 2000 by M. Terry, and the subject matter of this application is related to the subject matter of U.S. Pat. No. 5,711,980 issued on Jan. 27, 1998 to M. Terry, and to the subject matter of U.S. Pat. No. 6,050,391 issued on Apr. 18, 2000 to M. Terry, which subjects matter are incorporated herein by this reference.

### FIELD OF THE INVENTION

This invention relates to equipment and processes for processing and packaging fresh fish or poultry or meat to retard deterioration and promote extended shelf life.

### BACKGROUND OF THE INVENTION

Fish, poultry and meat products are commonly processed from catch or slaughter to market distribution in cold or frozen condition to retard the rate of decay of the product attributable to microorganisms present in the product. Extended shelf lives for such products commonly result from maintaining the products in frozen conditions during final processing, packaging, distribution and display. However, for such products that are not conducive to processing, packaging, distribution or display in frozen condition, icing down or otherwise refrigerating such products to cool, non-frozen condition is an alternative procedure that attains some extension of shelf life though not as extensively as in frozen condition. However, frozen product once thawed and non-frozen product commonly deteriorate rapidly out of an iced or refrigerated environment, attributable to microorganisms present on the surface of the product as well as within the product that remain present from initial processing and that are capable of rapid proliferation at elevated temperatures. In contrast to fresh produce that may be harvested in the field or orchard or vineyard and that is inherently immune from deterioration at the moment of harvest, fleshy products of fish, poultry and meat are notoriously more prone to rapid deterioration from the moment of catch or slaughter.

### SUMMARY OF THE INVENTION

In accordance with the present invention, fish, poultry and meat products are initially processed through a series of diverse environments including ambient vacuum and pressure conditions applied to processing fluids that tend to cycle the respiration rates of the product and significantly diminish the internal and surface concentrations of pathogens which affect decay of the product at elevated temperatures. The resultant product exhibits extended shelf life, even after freezing and thawing, and appealing marketability for enhanced product sales with reduced losses over longer processing, distribution and retailing intervals.

### BRIEF DESCRIPTION OF THE DRAWINGS

FIG. 1 is a pictorial diagram of successive environments for processing product in accordance with the present invention; and

FIG. 2 is a flow chart illustrating the process of the present invention;

FIG. 3 is a perspective view of a composite sheet material that is suitable for wrapping the processed product to selectively control the aspiration rate thereof;

FIG. 4 is a pictorial front view of a succession of pressure vessels in which controlled environments are established for processing product in accordance with another embodiment of the present invention;

FIGS. 5a-5b comprise a flow chart illustrating another embodiment of the process of the present invention;

FIG. 6 is a partial top view of a fluid circulating mechanism for the pressure vessels illustrated in FIG. 4; and

FIG. 7 is a pictorial illustration of a valve for the pressure vessels of FIG. 4.

### DETAILED DESCRIPTION OF THE INVENTION

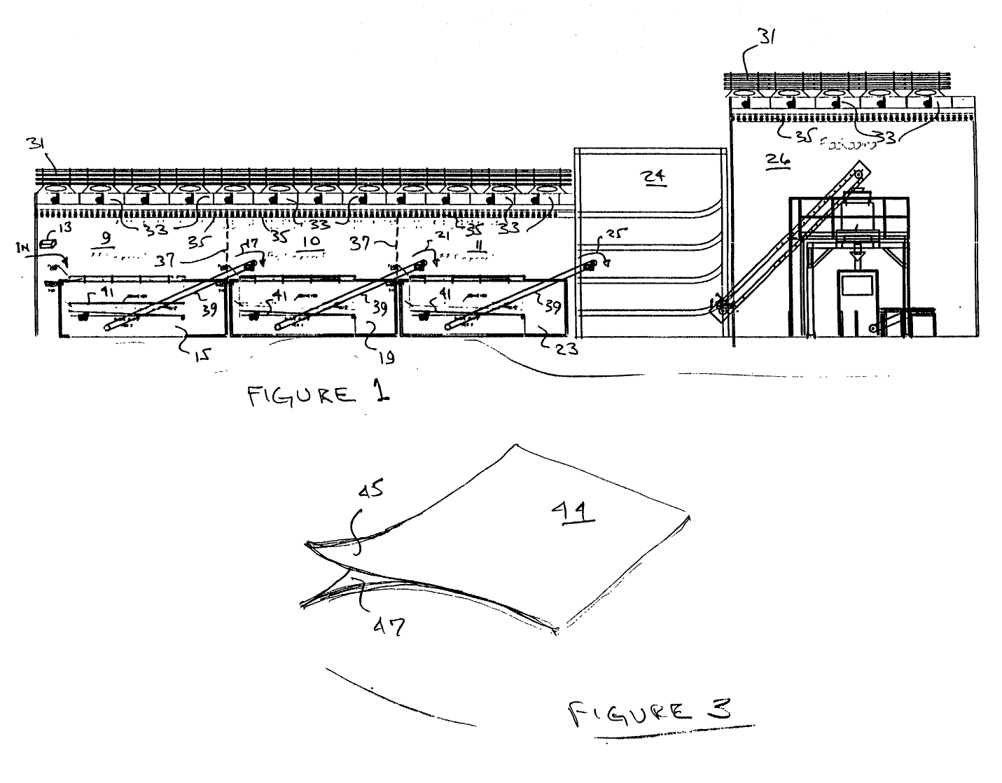

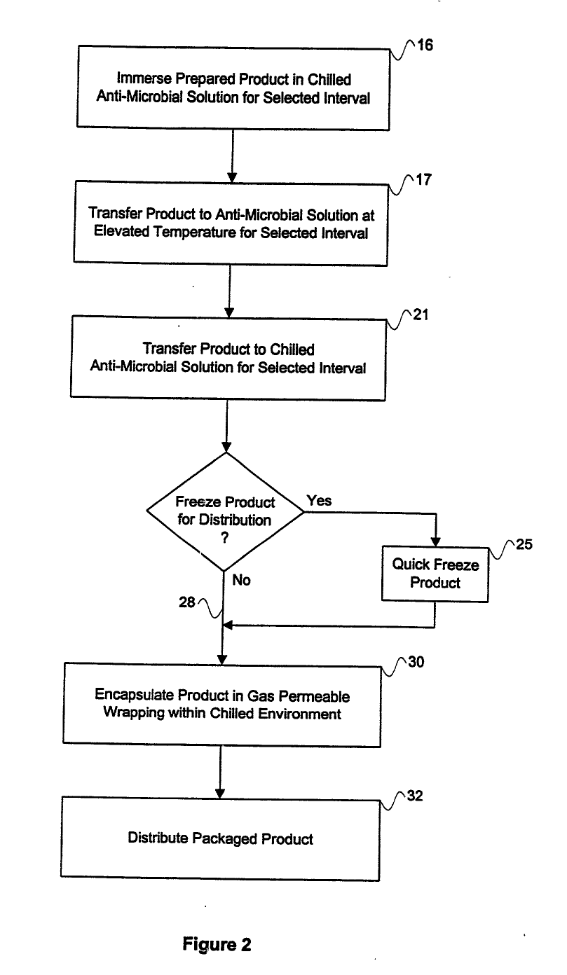

Referring now to FIGS. 1 and 2, there are shown pictorial diagrams of a product processing line and process containing several environments through which product 13 is processed according to the present invention, as illustrated in the flow chart of FIG. 2. Specifically, three successive environments 9,10,11 are assembled to receive fish, poultry or meat products 13 previously cleaned, scaled, filleted, or otherwise prepared or dressed from the initial natural state following catch or slaughter of the host animal. The first environment 9 includes a tank 15 containing a sanitizing solution of water and an anti-microbial agent such as peroxyacetic acid as a colorless, odorless, tasteless composition (commercially available as TSUNAMI 100) which is cooled to approximately 32°-35° F. and is circulated in the tank 15 at a concentration of about 85 parts per million parts water. The surrounding ambient conditions within environment 9 include air temperature at about 33°35 ° F. with relative humidity of about 98%. Product 13 is initially immersed 16 in the aqueous solution within tank 15 for about 1-3 minutes to effectively thermally shock the product, which is believed to elevate the cell respiration rate and prepare the product for the next processing environment. The dwell time of approximately 3 minutes ensures substantial reductions in surface bacterial concentrations at logarithmic rates per unit time of immersion, as is commonly known in the food processing industry. Products 13 of larger unit volumes greater than a cut size of about 10 pounds may require additional immersion time to accomplish comparable shock elevation of cell respiration rates and reductions in surface bacterial concentrations.

The product thus ‘shocked’ to a state of elevated cell respiration is then transferred 17 to the second environment 10 for immersion in a tank 19 containing an aqueous solution similar to the solution contained in tank 15 and that is circulating at a temperature of about 70°-105° F. The surrounding ambient conditions within environment 10 include air temperature at about 60°-95° F. with relative humidity of about 98%. It is believed that exposure of the product 13 to this sudden increase in temperature while at an elevated cell respiration rate expands the cell matrix and cell structure (vacuole) of the product analogous to opening up the pores of the product, and this facilitates increased penetration of the anti-microbial liquid agent into the cell matrix and cell structure (vacuole). This facilitates more thorough penetration of the product by the anti-microbial liquid agent in tank 19 which is thus rendered more effective in destroying pathogens within the cell matrix of the product 13. The product 13 remains immersed in tank 19 for about 3-7 minutes (dependent in part upon cut size and batch size) to affect substantial reductions in both the internal pathogens and any remaining surface bacteria, at rates of diminishing concentrations that vary logarithmically with time, in a manner that is commonly known in the food processing industry.

The product 13 thus elevated in temperature and exhibiting enhanced absorption of the anti-microbial liquid agent in tank 19 is then transferred 21 to the third environment 11 for immersion in tank 23 containing an aqueous solution similar to the solution contained in tank 15 and that is circulating at a temperature of about 32°-35° F. The surrounding ambient conditions within environment 11 include air temperature of about 33°-35° F. with relative humidity of about 98%. This sudden decrease in temperature lowers the cell respiration rate of the product 13 to near dormancy state and promotes expulsion of absorbed liquids. The product 13 remains immersed in the tank 23 for approximately 5-10 minutes (dependent in part upon cut size and batch size) to ensure maximum expulsion of absorbed liquid and to effect substantial reductions in remaining bacterial concentrations at logarithmic rates per unit time, in a manner that is commonly known in the food processing industry.

The product is then removed from the environment 11 and is transported 25 either to quick-freezing environment 24, or directly 28 to packaging facilities 26 within a cooled environment operating at a temperature of about 33° to 35° F. The product 13 thus transported (either via quick-freezing facility 24, or directly) to the packaging facilities 26 thus remains in dormant (or frozen) state with substantially reduced levels of pathogens that can adversely affect the deterioration of the product 13 thus processed according to the present invention.

Referring still to FIG. 1, the temperature and humidity and air purity conditions within the environments 9, 10, 11, 26 are carefully controlled in response to the air conditioning equipment that is shown assembled above each environment. Specifically, cooling coils 31 are disposed with respect to modular blower or fan units 33 that may be assembled in modular arrays with respect to each environment 9, 10, 11 and packaging facility 26 to transfer cooled air from about the coils 31 through fine HEPA filters 35 to the respective environments. Specifically, the HEPA filters 35 are selected to restrict passage therethrough of particles and contaminants not greater than about 0.3μ dimension, which therefore effectively filters out most, if not all, bacterial and pathogenic airborne contaminants. Such filters may also be assembled in modular arrays of about 2 foot by 4 foot panels for convenient cleaning and other servicing. Additionally, permeable curtains 37 such as overlapping vertical-hanging flexible strips of polyvinyl chloride (PVC) plastic material are disposed between environment 9, 10, 11 to facilitate maintaining temperature differentials in the adjacent environments 9, 10 and 10, 11.

The product 13 is transported between environments by conveyor mechanisms 39 which retrieve product 13 from the immersion tank 15, 19, 23 in one environment for transport to the next environment. And, within each immersion tank 15, 19, 23, the product 13 is kept moving through the immersion liquid composition by submerged conveyor mechanisms 41. In this way, dwell times of product 13 within each tank 15, 19, 23 may be controlled by the rate of movement of the submerged conveyor mechanism from an entry location for incoming product 13 to an exit location for outgoing product 13. And, the volumetric capacity of the tanks 15, 19, 23 may be sized proportionally to the dwell time of product 13 in each tank. Alternatively, the rate of product 13 entering environment 9 may be limited by the capacity of tank 23 that requires the longest product dwell time. In this way, continuous processing of product 13 may be accomplished without backup of product 13 into the slowest processing environment.

Where desirable, product 13 emerging 25 from the last processing environment 11 may be quick frozen in conventional manner within the freeze processing environment 24 for transfer to the final packaging phase in environment 26. Alternatively, product 13 emerging from the last processing environment 11 may be transferred 25 directly to the final packaging phase where frozen product is not desirable. The packaging environment 26 is also maintained at about 33° F. and relative humidity of about 98% via the cooling coils 31 and blower or fan modules 33 and HEPA filters 35, in the manner as previously described. In this environment, frozen product 13 transferred from the quick freeze environment 24 has only brief exposure time to non-freezing environment and has no opportunity to thaw while being wrapped and sealed or otherwise encapsulated 30 for retail distribution 32 under sustained freezing temperatures during transport and storage. Alternatively, product 13 transferred from environment 11 remains in non-frozen but dormant state during the brief interval while being wrapped and sealed or otherwise encapsulated 30 for retail distribution 32 under sustained near-freezing temperature during transport and storage.

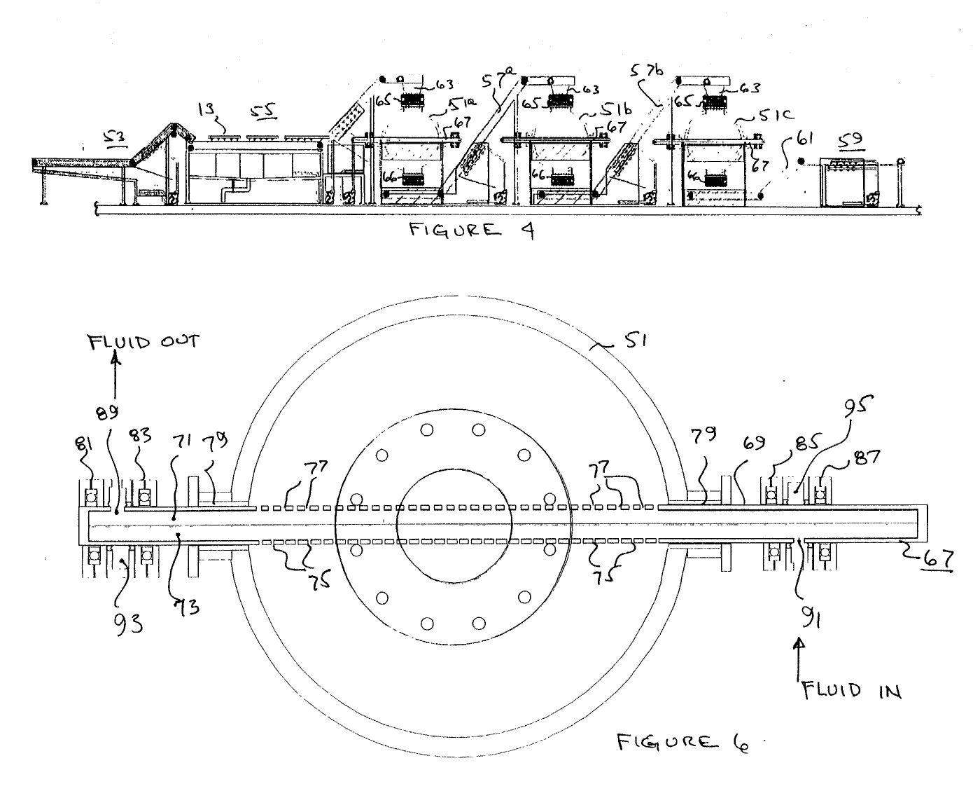

Referring now to FIG. 3, there is shown a composite flexible sheet material 44 that is applied to product 13 following processing thereof as previously described in accordance with the present invention. The composite sheet material 44 is formed as bonded layers of polyethylene film 45 over polypropylene film 47. This composite sheet material 44 is preferred as a sealing wrap about product 13 in frozen or dormant state for transportation and storage at the respective requisite temperatures during retail distribution because of the desirable gas permeability of such composite sheet material. Specifically, it has been discovered that such composite sheet material 44 transfers oxygen and carbon dioxide, among other gases, in a manner that retains an internal modified atmosphere of typically more than about 13% oxygen and less than about 5.5% carbon dioxide. The transmission rate of gases through the composite sheet material 44 may be altered by varying the thicknesses of the films 45, 47 that comprise the sheet material 44. Specifically, it has been determined that, for a thickness of the polypropylene film 45 of about 1.0-3.0 mils, and a thickness of the polyethylene film 47 of about 0.5-3.0 mils, the composite sheet material is capable of transferring about 0.01-50 microliters of oxygen per hour at freezing or near-freezing temperatures (dependent upon headspace analysis determinations of the respiration rates of the individual products 13 and their associates cuts). Such permeability with respect to oxygen is believed to benefit the product 13 wrapped and sealed in such composite sheet material because of the resultant reductions in excess oxygen available to accelerate the known KREBS cycle (i.e., the breakdown of carbon compounds generated during the decaying process limits or retards the decaying process). As the KREBS cycle, or decay cycle, is a resultant of carbolic actions taking place on and within the product 13 to generate carbon compounds, the modified environment in which the product 13 is sealed is significantly altered, in that, the amount of bacteria/pathogens/particulates in the modified atmosphere is significantly less, and the ability to break down the complex carbon compounds via excess oxygen in the sealed environment is significantly reduced.

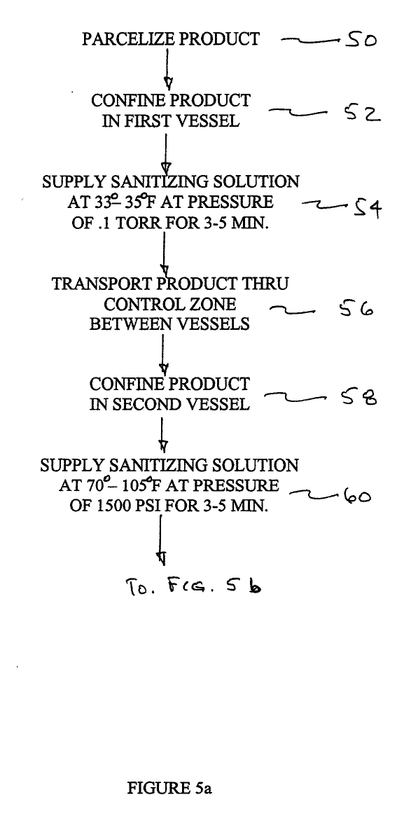

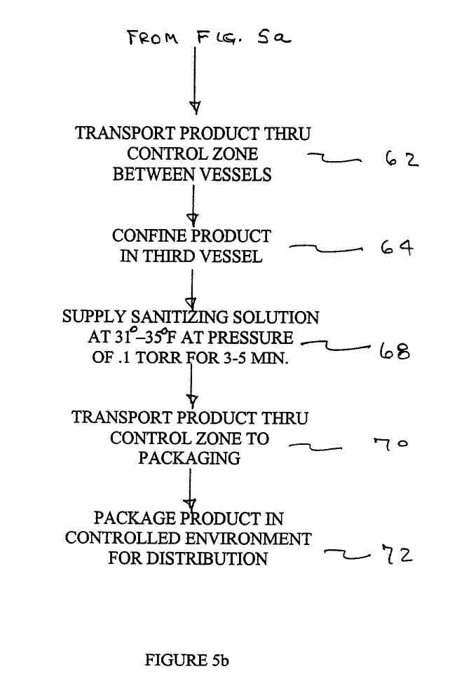

Referring now to FIG. 4, there is shown an arrangement of pressure vessels 51 and associated product conveyors for processing product 13 in accordance with another embodiment of the present invention, as illustrated in the flow chart of FIG. 5.

Specifically, a product in-feed conveyor 53 may extend from an initial product loading area to a conveyor work station 55 where product 13 is initially parcelized, sorted, or otherwise initially prepared 50 for processing through the succession of controlled environments established within the pressure vessels 51. The product 13 may be transported between vessels 51a, b, c via conveyors 57a, b, and then transported to final packaging 59 via conveyor 61. Some or all of the conveyors 53, 55, 57a, b may be configured and may operate as described in the aforecited U.S. Pat. No. 6,050,391.

A conveyor 55, 57a, b delivers product 13 into a hopper 63 that is disposed above a valve 65 at the top of each vessel. Each such valve 65, as illustrated in FIG. 7, may be a gate or slide valve, or the like, that is conducive to selectively passing parcelized or unit-sized product 13 from the hopper 63 into the vessel 51a, b, c. Similar valves 66 are disposed at the base of each vessel 51a, b, c. Each such valve 65, 66 may be hydraulically activated in synchronism with process requirements, as later described in detail herein.

Each of the vessels 51a, b, c is spherically shaped and sealed between the valves 65, 66 in the closed condition to sustain internal pressures up to about 1500 pounds per square inch, or vacuum levels to about 0.1 Torr during batch processing therein of product 13 loaded into the vessel through hopper 63 and valve 65. Processing sanitizing fluid such as liquid TSUNAMI, as previously described herein, is also introduced into a vessel 51a, b, c at a selected temperature for processing product 13 in a manner as described in detail later herein.

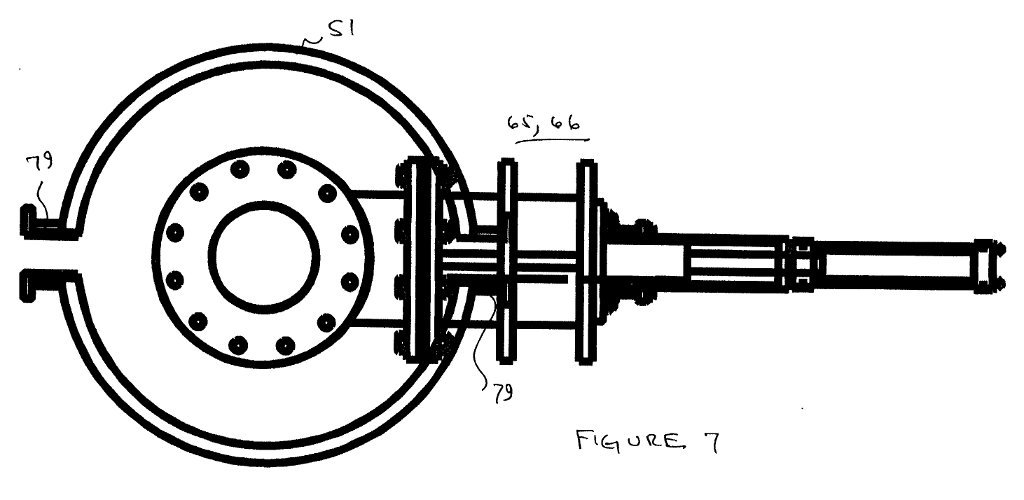

Referred now to FIG. 6, there is shown a partial top view of mixing apparatus 67 for each vessel that is disposed approximately diametrically through the vessel 51 to deliver and retrieve processing fluids in the vessel. Specifically, a shaft 69 includes two separated, axially-aligned lumens 71,73 that serve as inlet 73 and outlet 71 ports for processing fluids. The inlet lumen 73 includes a plurality of jets 75 disposed along substantially the diametric length of the portion of the lumen within a vessel 51a, b, c, and the outlet lumen 71 similarly includes a plurality of ports 77 disposed along substantially the diametric length of the portion of the lumen within the vessel. The set of jets 75 and the set of ports 77 are angularly displaced about the shaft 67, for example, by about 90° to promote an extended period of mixing of inlet liquid in the region near the shaft 67 prior to evacuating liquid from about the shaft as the shaft 67 rotates about its elongated axis. The shaft 67 is disposed to rotate within fluid-tight seals 79, and is rotatably supported by sets of bearing 81, 83 and 85, 87 near opposite ends of the shaft 67. Fluid couplings to the separated lumens 71, 73 are formed via apertures 89, 91 that are disposed near opposite ends of the shaft 67, and that communicate with respective fluid channels 93, 95 which surround the shaft 67 within fluid-tight seals. In this way, product 13 that is immersed in liquid for processing within a vessel 51a, b, c, is agitated and kept moving in response to liquid circulated under pressure in through jets 75 and out through ports 77.

In operation, as illustrated in the flow chart of FIG. 5, product 13 that is initially delivered for processing in accordance with the present invention enters along conveyor 53 for delivery to the work station 55 at which preliminary processing such as unit sizing and washing and spacing along the conveyor, and the like, are performed. As valve 65 opens at the top of an initial processing vessel 51a, product 13 is transported via conveyor 55 for delivery through the hopper 63 and valve 65 into the vessel 51a, with valve 66 at the bottom of the vessel closed. When sufficient product 13 is delivered to the vessel 51a, valve 65 closes to confine 52 the product within the vessel 51a and a processing fluid such as a mixture of water and TSUNAMI at a temperature of about 33-35° F. is introduced 54 into the vessel and section is applied. The internal pressure is then reduced to about 0.1 Torr. This initial processing of product 13 causes an increased reverse osmotic effect of the solution which prepares the cellular matrix which has been partially contracted to effect the “kill” step to follow. During such processing within a vessel 51a, the processing liquid is circulated into and out of the vessel via the inlet and outlet lumens 71,73 in the rotating shaft 67 to replenish the supply of active ingredients or to agitate and circulate product within the vessel.

After an interval of about 3 minutes of such initial processing in vessel 51a, the internal pressure is normalized and the valve 66 at the bottom of the vessel is opened to release the volume of liquid and product 13 onto the next conveyor 57a for transport 56 to the next or intermediate stage of processing in vessel 51b. A contracted cellular matrix state in the product 13 is thus achieved and maintained while passing to the next phase of the process. The liquid drains through a porous conveying surface into a sump for collection, filtering, heating or cooling (dependent upon the incumbent thermal exchange) and refurbishment of active ingredients prior to being resupplied to the vessel 51a during processing therein of a subsequent batch of product 13.

In similar manner as previously described with reference to loading product 13 into vessel 51a, the product 13 that is transported from vessel 51a to vessel 51b via conveyor 57a is loaded through hopper 63 and open valve 65, with valve 66 closed. After a sufficient quantity of product 13 is loaded into the vessel 51b, the valve 65 is closed to confine 58 the product 13 within the vessel 516, and processing fluid such as described previously is introduced into the vessel 60 at elevated temperature of about 70-105° F. The internal pressure is then elevated to about 29 Torr (1500 psi) for an interval of about 3-5 minutes, during which time processing liquid is circulated in the manner as previously described herein via the dual-lumen rotating shaft 67. This intermediate processing in vessel 51b causes an expansion of the cellular matrix and an increased osmotic effect allowing for an increased rate of penetration of sanitizing solution to the cellular walls and into the interior portions of the cells. At the end of the processing interval, the internal pressure in vessel 51b is normalized to ambient pressure, and the valve 66 at the bottom of the vessel 51b is opened to release the volume of processing liquid and product 13 onto the next conveyor 57b. An expanded cellular matrix state in the product 13 is thus achieved and maintained while passing 62 to the next phase of the process. Liquid is separated from the product 13, in the manner as previously described herein, by the conveyor 57b that transfers the product 13 to vessel 51c for final processing therein prior to packaging operations at work station 59.

In similar manner, as previously described herein, the product 13 is transported via conveyor 57b from vessel 51b to vessel 51c for loading therein through hopper 63 and open valve 65, with valve 66 closed. After a sufficient quantity of product is loaded into the vessel 51c, the valve 65 is closed to confine 64 the product 13 within the vessel 51c, and processing fluid such as previously described is introduced into the vessel 68 at reduced temperature of about 33-35° F. The internal pressure is then reduced to about 0.1 Torr for an interval of about 3-5 minutes, during which time processing liquid is circulated in the manner as previously described herein via the dual-lumen rotating shaft 67.

This final processing in vessel 51c (prior to packaging operations 59) causes a contraction of the cellular matrix and an expulsion of undesirable fluids from the tissue, as well as creating a ‘dormancy” state of cellular respiration in preparation for final packaging. At the end of the processing interval, the internal pressure is normalized to ambient pressure, and the valve 66 at the bottom of vessel 51c is opened to release the volume of processing liquid and product 13 onto conveyor 61. A less-than-beginning cellular matrix state in the product 13 is thus achieved and maintained while passing to the next phase of the process. Liquid is separated from the product 13, in the manner as previously described herein, by the conveyor 61 that transfers 70 the processed product 13 to the packaging operations 72. The cellular matrix begins to expand to its initial state (e.g., at the beginning of the process) from the near-dormant respiration rate that was achieved through the previous processing, and this automatically dries the exterior of the product 13 and reduces the growth of pathogens which breed in oxygen and moisture.

At each transition of product 13 with respect to processing vessels 51a, b, c, the ambient conditions of temperature and relative humidity about the product 13 on a conveyor 53, 55, 57a, b, 61 may be controlled within control zones 56, 62, 70 that are bounded by moving air curtains, or flexible strips forming boundary walls, or the like. In an initial one of such control zones incorporating the work station 55 the temperature and humidity conditions are preferably set at about 33-35° F. and about 98% RH in the “shock” phase. In a subsequent control zone incorporating the conveyor 57a, the temperature and humidity conditions are preferably set at about 70 105° F. and about 98% RH in the phase of cellular matrix expansion and absorption of fluids. In the control zone incorporating the conveyor 57b, the temperature and humidity conditions are preferably set at about 31-35° F. and about 98% RH in the phase of contracted cellular matrix and dormancy cellular respiration and, in the control zone incorporating conveyor 61, the temperature and humidity conditions are preferably set at about 1° C. and 98% RH to maintain the dormancy cellular respiration state through packaging.

This succession of control zones (typically, at ambient pressure) along the course of processing stages has the effect of maintaining the desired cellular matrix state and cellular respiration rate at the respective elevated or near dormancy state. All ambient air circulating around product through the stage of processing is filtered for excluding particulate contaminants greater than about 0.12μ inches from the ambient air in the environment within which the product is transported and encapsulated. This modified environment significantly reduces the possibility of cross contamination and environmental contamination from “outside” pathogens.

Equipment for filtration, and cooling and heating of the control zones and the processing liquids, as well as for pressurizing vessels and processing liquids and hydraulic fluids, may all be housed remotely from the processing of product 13 through the assembly of vessels 51a, b, c, and be piped and ducted thereto in order to preserve sanitary conditions in the ambient environment and to avoid contaminants from machine-oriented sources.

Therefore, animal products processed in accordance with the invention exhibit much slower growth of bacteria and a retardation of the KREBS cycle. The apparatus and processes of the present invention thus greatly reduce pathogenic contaminants that contribute to the deterioration of animal products prepared for retail distribution, and thereby significantly increase retail shelf life and sanitary packaging of such products.

What is claimed is:

1. Apparatus for processing fish or poultry or meat products, comprising:
a plurality of process stations, each including an immersion chamber and ingress and egress for product, one of the process stations including a vessel containing sanitizing liquid at about 70°-105° F. for receiving product therein and another of the process stations including a vessel containing sanitizing liquid at about 32°-35° F. for receiving product therein; and
a transport system for transferring product between process stations.

2. Apparatus according to claim 1 comprising:
a first of the plurality of process stations including a vessel containing sanitizing liquid at about 33° F. for receiving product therein prior to transfer therefrom of the product to the one process station.

3. Apparatus according to claim 1 in which the transport system operates within a confined environment and includes a packaging station disposed to package the product, said confined environment including an air circulating module disposed to filter particulate contaminants from air circulated thereby within the confined environment.

4. Apparatus for processing fish or poultry or meat products, comprising:
a plurality of work stations including at least two immersion chambers operating at different temperatures, each work station including ingress and egress for product transfers;
a transport system communicating with an ingress or egress for at least one work station for transferring product thereby, said transport system operating within an environment including ambient air; and
a structure associated with the environment for circulating ambient air therethrough to remove particulate material from the ambient air.

5. Apparatus according to claim 4 in which the transport system includes conveyor apparatus communicating with egress from a work station to transfer product to a packaging station, said packaging station operating within an environment for encapsulating the product within the environment of the packaging station.

6. Apparatus according to claim 5 in which the packaging station includes a structure for cooling and filtering ambient air in the environment within which the product is encapsulated.

7. Apparatus according to claim 6 including an air filter for excluding particulate contaminants greater than above 0.3μ inches from ambient air in the environment within which the product is encapsulated.

8. Apparatus according to claim 6 including a structure disposed relative to the environment within which the product is encapsulated for cooling ambient air therein to about 33°-35° F.

9. Apparatus according to claim 1 in which at least one of the immersion chambers is operable at internal pressure different from ambient pressure.

10. Product encapsulating material comprising:
a first flexible layer of polypropylene, and integrated therewith,
a second flexible layer of polyethylene to form a composite flexible sheet material exhibiting selected gas permeability characteristics for wrapping about processed product as an encapsulating barrier to control gas transfers through the composite flexible sheet material relative to processed product encapsulated thereby.

11. Product encapsulating material as in claim 10 in which the first layer has a thickness in the range of about 1.0 to 3.0 millimeters.

12. Product encapsulating material as in claim 10 in which the second layer has a thickness in the range of about 0.5 to 3.0 millimeters.

13. Apparatus for processing animal products comprising a plurality of process stations each including a chamber disposed to operate at pressure different from ambient pressure and including ports selectively operable between open and fluid-tight closed conditions for controlling ingress and egress of product; and
a transport system for transferring product from an egress port of one chamber to the ingress port of a successive chamber.

14. Apparatus according to claim 13 in which the ports each include a valve disposed to pass product therethrough in open condition and to form fluid-tight seal in closed condition.

15. Apparatus according to claim 13 including a tube positioned within at least one of the chambers and including a plurality of apertures therein for transferring fluid therethrough within the chamber.

16. Apparatus according to claim 15 in which the tube is disposed to rotate about an elongated axis thereof within the chamber for altering the orientation of the apertures within the chamber during transfer of fluid.

17. Apparatus according to claim 15 in which the tube includes first and second separated lumens therein along an elongated axis, and includes a plurality of apertures in each lumen for introducing fluid into the chamber through the first lumen and apertures therein, and for evacuating fluid from the chamber through the second lumen and apertures therein.

18. Apparatus according to claim 17 in which the tube is disposed to rotate about the elongated axis thereof within the chamber to alter the angular orientation of the apertures within the chamber in response to rotation of the tube.

19. Apparatus according to claim 18 including collars disposed to surround the tube in fluid-tight sealing engagement therewith for forming fluid channels therein to communicate with an aperture in each lumen outside the chamber during rotation of the shaft about the elongated axis thereof.

20. A method for processing animal products, comprising:
immersing the product in a sanitizing solution at approximately 32°-35° F. and at a selected pressure for not more than about 3 minutes of a first time interval;
after the first time interval, immersing the product in a sanitizing solution at approximately 70°-105° F. and at a selected pressure for about 3-5 minutes of a second time interval;
after the second time interval, immersing the product in a sanitizing solution at approximately 33°-35° and at a selected pressure for about 3-5 minutes of a third time interval; and
after the third time interval, preparing the product for distribution.

21. The method according to claim 20 in which the first, second and third time intervals are in the range of about 1 to 10 minutes.

22. The method according to claim 20 in which the third time interval is longer than the second time interval which is longer than the first time interval.

23. The method according to claim 20 in which the sanitizing solution is circulated around the product during at least one of the first, second and third time intervals.

24. The method according to claim 20 in which the selected pressures during the first, second and third time intervals are in the range from about 0.1 Torr to about 1,500 psi.

25. The method according to claim 20 in which the selected pressure during the first time interval is about 0.1 Torr.

26. The method according to claim 20 in which the selected pressure during the second time interval is about 1,500 psi.

27. The method according to claim 20 in which the selected pressure during the third time interval in about 0.1 Torr.
